(19) United States
(12) Patent Application Publication
(10) Pub. No.: US 2009/0103746 A1
(43) Pub. Date: Apr. 23, 2009

(54) AUDIO ADAPTER HAVING VOLUME ADJUSTING FUNCTION

(75) Inventors: CHANG-CHUN LIU, Shenzhen (CN); XIAO-LIN GAN, Shenzhen (CN); YU-KUANG HO, Tu-Cheng (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 11/947,779

(22) Filed: Nov. 30, 2007

(30) Foreign Application Priority Data
Oct. 22, 2007 (CN) 200710202191.X

(51) Int. Cl. H04R 1/10

(52) U.S. Cl. 381/74

(57) ABSTRACT

An audio adapter includes a first audio interface and a second audio interface. The first audio interface includes a left ear audio pin and a right ear audio pin. The second audio interface includes a left ear audio pin and a right ear audio pin. The left ear audio pin of the first audio interface is connected to the left ear audio pin of the second audio interface via a first variable resistor. The right ear audio pin of the first audio interface is connected to the right ear audio pin of the second audio interface via a second variable resistor.

### BACKGROUND

1. Field of the Invention

The present invention relates to audio adapters, and particularly to an audio adapter which can adjust volume of an audio signal thereof.

2. Description of Related Art

Nowadays, earphone sets are already used in many audio devices, such as mobile telephone, MP3, etc. Earphone sets are designed with a lot of different types of interfaces, such as 2.5 mm/3.5 mm audio interface and universal serial bus (USB) audio interface. Thereby, some audio adapters are designed to adapt a device to accommodate these different types of audio interfaces.

However, these audio adapters can only transmit audio signals and have no other functions. When two users use an earphone set at the same time, each of them may want to use an earphone of the earphone set, they cannot adjust volume respectively, thereby the earphone set can not satisfy the two users at the same time, which is very inconvenient.

What is needed is to provide an audio adapter which has volume adjusting function.

### SUMMARY

An embodiment of an audio adapter includes a first audio interface and a second audio interface. The first audio interface includes a left ear audio pin and a right ear audio pin. The second audio interface includes a left ear audio pin and a right ear audio pin. The left ear audio pin of the first audio interface is connected to the left ear audio pin of the second audio interface via a first variable resistor. The right ear audio pin of the first audio interface is connected to the right ear audio pin of the second audio interface via a second variable resistor.

Other advantages and novel features of the present invention will become more apparent from the following detailed description of an embodiment when taken in conjunction with the accompanying drawings, in which:

### BRIEF DESCRIPTION OF THE DRAWING

FIG. 1 is an isometric view of an audio adapter in accordance with an embodiment of the present invention;

FIG. 2 is a top plan view of FIG. 1; and

FIG. 3 is a circuit diagram of the audio adapter of FIG. 1.

### DETAILED DESCRIPTION

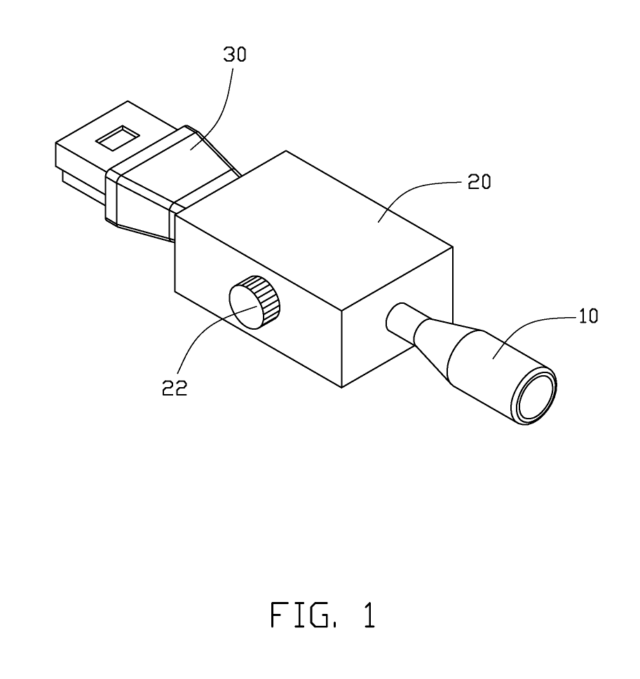

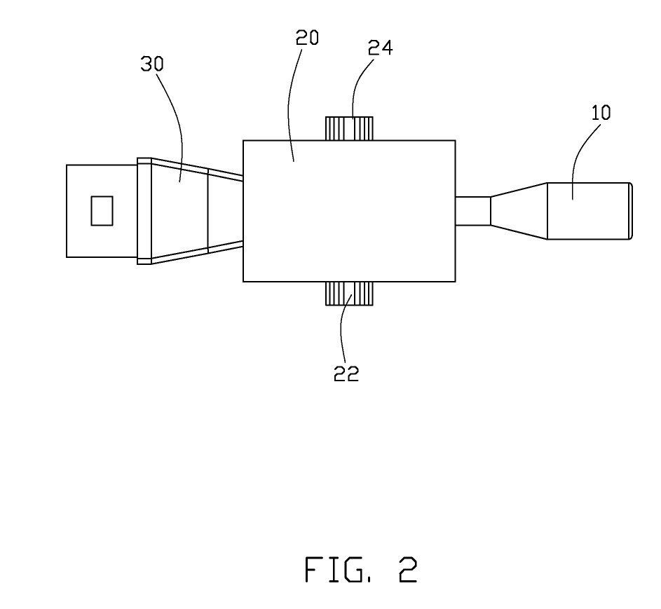

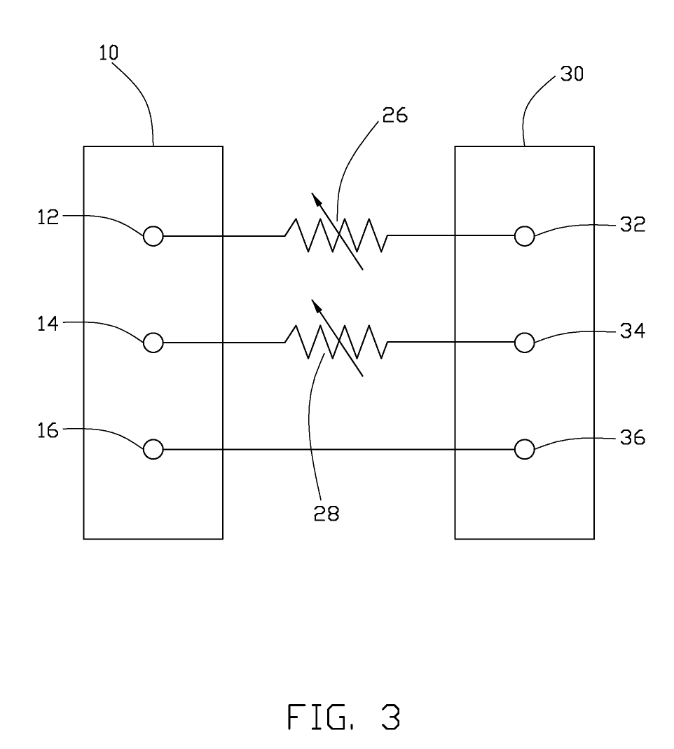

Referring to FIGS. 1 to 3, an audio adapter in accordance with an embodiment of the present invention includes a first audio interface 10, a main body 20, a second audio interface 30, a first knob 22, a second knob 24, a first variable resistor 26, and a second variable resistor 28. In this embodiment, the first audio interface 10 is a 3.5 mm audio interface and the second audio interface 30 is a USB audio interface. The first audio interface 10 and second audio interface 30 can be designed with other types of audio interfaces according to need.

The first audio interface 10 and second audio interface 30 are respectively mounted on opposite ends of the main body 20. The first knob 22 and second knob 24 are respectively mounted on opposite sides of the main body 20. The first variable resistor 26 and second variable resistor 28 are installed in the main body 20. The first knob 22 is connected to an adjusting terminal of the first variable resistor 26 to adjust the resistance of the first variable resistor 26. The second knob 24 is connected to an adjusting terminal of the second variable resistor 28 to adjust the resistance of the second variable resistor 28.

The first audio interface 10 includes a left ear audio pin 12, a right ear audio pin 14, and a ground pin 16. The second audio interface 30 includes a left ear audio pin 32, a right ear audio pin 34, and a ground pin 36. The left ear audio pin 12 of the first audio interface 10 is connected to the left ear audio pin 32 of the second audio interface 30 via the first variable resistor 26. The right ear audio pin 14 of the first audio interface 10 is connected to the right ear audio pin 34 of the second audio interface 30 via the second variable resistor 28. The ground pin 16 of the first audio interface 10 is connected to the ground pin 36 of the second audio interface 30.

In use, an audio interface of an earphone set is connected to the first audio interface 10. An audio interface of an audio device, such as a mobile telephone, is connected to the second audio interface 30. When the audio device transmits an audio signal, the earphone set will receive the audio signal from the audio device. If two users use the earphone set at the same time, and each want to use an earphone of the earphone set, they can adjust volume respectively via the first knob 22 and the second knob 24, which is very convenient.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An audio adapter comprising:
a first audio interface having a left ear audio pin and a right ear audio pin; and
a second audio interface having a left ear audio pin and a right ear audio pin, the left ear audio pin of the first audio interface connected to the left ear audio pin of the second audio interface via a first variable resistor, the right ear audio pin of the first audio interface connected to the right ear audio pin of the second audio interface via a second variable resistor.

2. The audio adapters as claimed in claim 1, wherein the first variable resistor and second variable resistor are installed in a main body having a first knob and a second knob mounted thereon, the first knob is connected to an adjusting terminal of the first variable resistor to adjust the resistance thereof, the second knob is connected to an adjusting terminal of the second variable resistor to adjust the resistance thereof.

3. The audio adapters as claimed in claim 2, wherein the first audio interface and second audio interface are respectively mounted on opposite ends of the main body, the first knob and second knob are respectively mounted on opposite sides of the main body.

4. The audio adapters as claimed in claim 1, wherein the first audio interface is a 3.5 mm audio interface and the second audio interface is a universal serial bus (USB) audio interface.
